(19) United States
(12) Patent Application Publication
(10) Pub. No.: US 2007/0226133 A1
(43) Pub. Date: Sep. 27, 2007

(54) Membership-based mortgage purchases

(76) Inventor: Daniel R. Zufall, Eden Prairie, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/801,652

(22) Filed: May 10, 2007

(51) Int. Cl. G06Q 40/00

(52) U.S. Cl. 705/38

(57) ABSTRACT

A membership program for mortgage purchases discounts the costs normally paid by the homeowner when taking out a mortgage, yet provides a reasonable profit to the brokerage or direct lending institution. Membership is maintained by payment of an initial membership fee and periodic membership dues. The member is entitled to discounted closing expenses are discounted for each mortgage purchased through a broker or from a lender, who reduces or waives various common fees usually received by the broker or lender, or pays certain costs in full or in part on behalf of the member homeowner. The member is also offered the mortgage product whose characteristics are most favorable to the member, such as illustratively the lowest interest rate. Additional benefits of membership may include predictable monthly dues, and various discounted personalized information and services.

### BACKGROUND OF THE INVENTION

1. Field of the Invention

This invention relates to mortgages, and more particularly to broker and lending institution compensation for mortgage purchases.

2. Description of Related Art

The mortgage industry primarily has two different types of entities to which customers may apply for a mortgage, namely mortgage brokers, and direct lending institutions such as banks, credit unions, savings and loan institutions, and so forth. According to the Minnesota Association of Mortgage Brokers (“MNAMB”), mortgage brokers currently account for 70% of the mortgages originated nationwide, and direct lending institutions account for the remaining 30%.

FIG. 1 shows an example of a business model for the typical mortgage broker 100 which typically employs one or more loan officers LO. While a typical mortgage broker has thousands of customers over a career, only two customers C1 and C2 are considered for simplicity. Customer C1, a homeowner, has a number “n” of mortgage purchases M over the homeowner's ownership lifetime. Transaction 102 relates to purchase of mortgage M1 by customer C1, transaction 104 relates to purchase of mortgage M2 by customer C1, and transaction 106 relates to purchase of mortgage M3 by customer C1. Customer C2 is less active, having only one mortgage purchase M1 over his home ownership lifetime, which is shown as transaction 108. For customer C1, mortgage M1 in transaction 102 may be for an initial home purchase, mortgage M2 in transaction 104 may be for a replacement home purchase, and mortgage M3 in transaction 106 may be a refinance for the replacement home. For customer C2, transaction 108 may be an initial home purchase. Each mortgage purchase is essentially treated as an independent transaction for the purpose of the transaction fees TF, as far as the mortgage broker 100 is concerned.

Mortgage brokers are compensated typically as follows. One source is fees directly charged to the customer by the broker, including but not limited to: origination fees, discount points, broker fees, processing fees, application fees, document preparation fees, and administrative fees. Another source is a “yield spread premium” or “broker compensation,” which are paid to the broker by the actual lender who underwrites and approves the loan. The lender may in turn either service the payments or sell the servicing rights in the secondary market, thus freeing up credit to approve more loans. Another source is a sale for profit of the mortgage in the secondary market. The broker may do this if the broker has a “warehouse line” or a large line of credit used to approve and fund loans internally, and is willing to forego the initial yield spread premium. This method is used primarily by larger mortgage brokers.

Mortgage brokers, much like real estate agents, typically enjoy high profit margins per file, which enables a company or individual loan officer to do a small number of transactions annually yet earn a good income. Mortgage brokers hire individual loan officers to originate mortgages, who then rely heavily and most often solely on commissions earned from clients they bring into the company through their own personal marketing and networking efforts. This standard business practice essentially turns each loan officer into his/her own small business, so that each mortgage brokerage is made up of these individual small businesses who market themselves to gain a clientele and earn commissions, in a manner very similar to real estate agents.

FIG. 2 shows an example of a business model for the typical direct lending institution 200. This business model is essentially the same as the broker model of FIG. 1, except that a direct lending institution 200 replaces the broker 100. Each mortgage purchase is essentially treated as an independent transaction for the purpose of the transaction fees TF, as far as the direct lending institution 200 is concerned.

Direct lending institutions are compensated typically as follows. One source is fees directly charged to the customer by the direct lending institution, including but not limited to: origination fees, discount points, broker fees, processing fees, application fees, document preparation fees, administrative fees, commitment fees, and underwriting fees. Another source is actual interest that accrues on the loan from servicing the mortgage payments and carrying the note is paid to the direct lending institution. Another source is revenue from the sale for profit of the mortgage by the direct lending institution in the secondary market. This sale may be immediate or some time after the mortgage is closed. Alternatively, the direct lending institution may choose to service the loan to maturity.

Direct lending institutions hire loan officers to work for them, primarily for customers that the direct lending institution already has or brings in from its own marketing efforts. Typically, the direct lending institution pays a base salary plus, perhaps, a smaller bonus or other type of commission per file to the loan officer. The profit margins per file are much smaller for the loan officer, who is more dependent on the corporate salary and the company's customers rather than on commissions and customers brought in by the loan officer.

For both the broker business model and the direct lending institution model, expenses to the customer are substantial and are levied on the basis of each mortgage transaction. Typical fees and costs charged to the customer per transaction typically include: an origination or broker fee of typically one percent; a processing fee of typically between $300 and $500; application, administration and document preparation fees of typically between $300 and $500; credit report fee of typically between $10 and $58; and an underwriting fee of typically between $500 and $800. On a $200,000 mortgage, for example, the broker and lender fees typically range between $3100 and $3858. Since the average homeowner refinances every three to five years and sells every seven to ten years, an average homeowner experiences from six to ten transactions for which the cumulative broker and lender fees would range from $18,660 to $38,530 (assuming each transaction involves a $200,000 mortgage).

Moreover, many consumers find the need to investigate mortgage market conditions and to identify a new broker or institution for each mortgage transaction to be difficult and time-consuming, and find that working with different brokers and institutions for each mortgage transaction can be frustrating and anxiety-provoking. FIG. 3 shows how a typical customer makes mortgage purchases over a lifetime of home ownership. If the customer wishes to acquire a home (block 302-yes), the customer must identify the home (block 320), investigate the mortgage market (block 322), and identify a suitable broker (block 324). In due course the mortgage purchase closes (block 326). The customer may at some point decide that he wishes to consider refinancing (block 304-yes). This often happens in a serendipitous way, as when the customer learns about the desirability of refinancing from an article in a newspaper or financial journal, or from a personal finance program on the radio or television. At that time, the customer investigates the mortgage market (block 330) and decides whether to refinance (block 332). If the decision is to refinance (block 332-yes), the customer identifies a suitable broker (block 334). In due course the mortgage purchase closes (block 336).

In summary, while this system has worked well for quite some time, the cost to the customer is substantial, and each mortgage purchase can be frustrating, difficult and time-consuming for the customer.

### BRIEF SUMMARY OF THE INVENTION

What is needed is an approach to mortgage lending that reduces the cost and increases the convenience of mortgage purchases to the customer while fairly compensating the mortgage broker. These and other objects and/or advantages are achieved in the present invention.

In one embodiment, the present invention is a method of providing mortgage services comprising establishing an entity prospectively requiring mortgage services as a member, wherein the member is obligated to make at least one payment to maintain member status; receiving a request from the member to purchase a mortgage; identifying a mortgage characteristic that is favorable to the member; accessing a portfolio of mortgage products to identify a mortgage most suitably matched to the favorable mortgage characteristic, in response to the mortgage purchase request; offering the identified mortgage to the member; and discounting closing expenses to the member relating to closure of the offered mortgage.

Another embodiment of the present invention is a method for a broker to provide mortgage services comprising establishing a portfolio of lenders offering a variety of competitively priced mortgage products; establishing an entity prospectively requiring mortgage services as a member upon receipt of an initial membership fee; maintaining member status of the member upon receipt of periodic membership dues; receiving a request from the member to purchase a mortgage, the request being for a first mortgage loan amount of at least a predetermined minimum amount; offering from the portfolio of lenders a mortgage most suitably matched to the member's needs, the offered mortgage being a lowest interest rate of mortgage products for which the member qualifies; receiving a one percent yield spread premium, in connection with closing of the offered mortgage; waiving origination and application fees from the member, in connection with closing of the offered mortgage; and paying processing, credit report, and underwriting fees on behalf of the member, in connection with closing of the offered mortgage.

Another embodiment of the present invention is a method of providing franchised mortgage services comprising empowering each of a plurality of brokers to establish an entity prospectively requiring mortgage services as a member, wherein the member is obligated to make at least one payment to maintain member status; to receive a request from the member to purchase a mortgage; to identify a mortgage characteristic that is favorable to the member; to access a portfolio of mortgage products for identifying a mortgage most suitably matched to the favorable mortgage characteristic, in response to the mortgage purchase request; to offer the identified mortgage to the member; and to discount closing expenses to the member relating to closure of the offered mortgage. Respective fees are received from the brokers in consideration of the empowering step. A variation of this embodiment further comprises establishing the portfolio of mortgage products from a portfolio of lenders offering a variety of competitively priced mortgage products.

### BRIEF DESCRIPTION OF THE SEVERAL VIEWS OF THE DRAWINGS

FIG. 1 is a schematic diagram showing the completion of mortgage purchases in a prior art method.

FIG. 2 is a schematic diagram showing the completion of mortgage purchases in another prior art method.

FIG. 3 is a flowchart showing the completion of mortgage purchases in a prior art method.

FIG. 4 is a schematic diagram showing the completion of mortgage purchases in accordance with the present invention.

FIG. 5 is a flowchart showing the completion of mortgage purchases in accordance with the present invention.

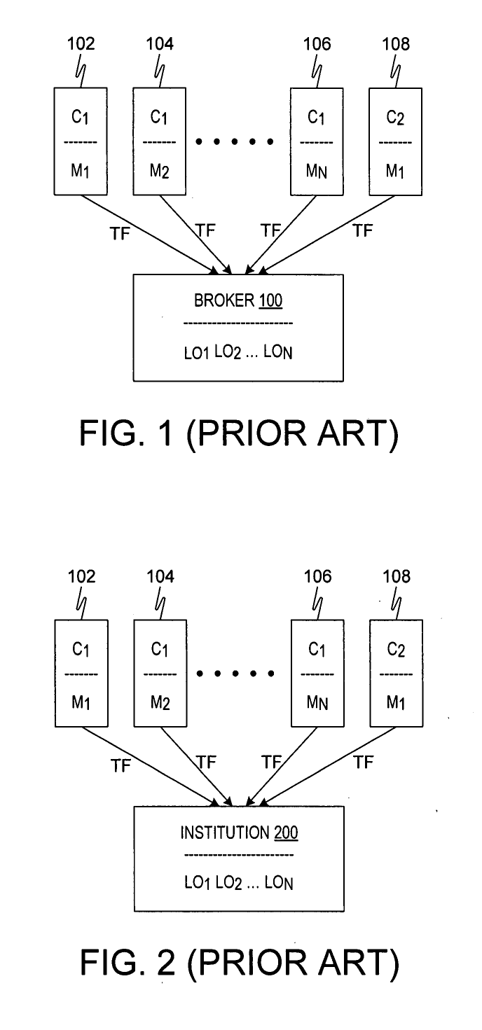

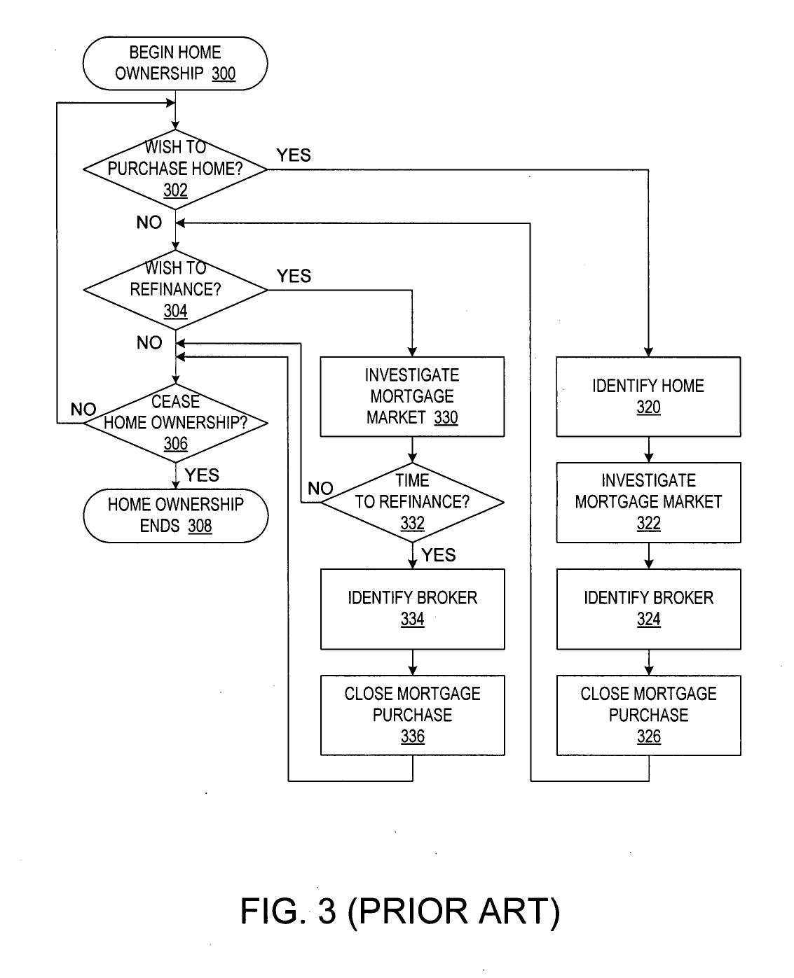

### DETAILED DESCRIPTION OF THE INVENTION, INCLUDING THE BEST MODE

The membership program described herein discounts the costs normally paid by the homeowner when taking out a mortgage, yet provides a reasonable profit to the brokerage or direct lending institution. First, second, and refinanced mortgage purchases may be included in the membership program. Homeowners, which term includes prospective homeowners, may become members of the mortgage purchase program. The member's closing expenses are discounted for each mortgage purchased through a broker or from a lender, who reduces or waives various common fees usually received by the broker or lender, or pays certain costs in full or in part on behalf of the member homeowner. The member is also offered the mortgage product whose characteristics are most favorable to the member, such as illustratively the lowest interest rate. In the case of a broker, the most favorable mortgage is selected from the broker's portfolio of lenders. Advantageously, an active member may enjoy substantial savings on the order to tens of thousands of dollars over his or her home ownership lifetime.

A significant benefit of membership in the case of a broker-hosted program is the broker's guarantee to give the member the lowest rate available through the broker's portfolio of lenders on the specific type of loan the member desires and for which the member qualifies. Preferably, the broker's portfolio of lenders offers a variety of competitively priced mortgage products. Preferably, the mortgage products in the portfolio also yield the broker the standard one percent yield spread premium paid by the lender and standard to the industry quoted interest rates. The broker may further agree that any additional to the one percent will be applied toward the member's closing costs.

The broker or lender may offer additional savings to the member by offering additional discounted services, such as meetings with experienced brokerage personnel, personalized newsletters and market trends based on the member's profile and history in the program, and targeted seminars. The discounts may range from one hundred percent, i.e. free or no-cost, to reduced or deferred cost.

To become a member, a homeowner pays an initial membership fee and periodic membership dues. Membership dues may be fixed and periodically due and payable throughout the period of membership, or adjusted from time to time based on a fixed factor, index-based, or otherwise in a predictable or predetermined manner. Membership may be terminated upon payment of a termination fee.

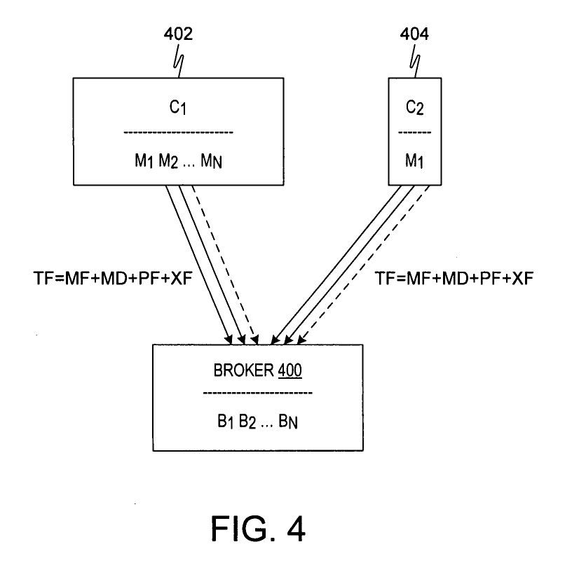

FIG. 4 shows an example of a business method for a membership-based mortgage purchase program for illustratively a broker 400. A similar business method may also be structured around a direct lending institution. While a typical mortgage broker has thousands of customers over a career, only two customers C₁ and C₂ are considered for simplicity. Customer C₁, a homeowner, has a number “N” of mortgage purchases M1 through M_{N} over the homeowner's ownership lifetime, while customer C₂ is much less active, having only one mortgage purchase M₁ over his home ownership lifetime. For customer C₁, mortgage M₁ may be for an initial home purchase, mortgage M₂ may be for a replacement home purchase, and mortgage M₃ may be a refinance for the replacement home. For customer C₂, mortgage M₁ may be an initial home purchase.

Conceptually, the membership-based mortgage purchase model views the customer relationship as the transaction, for purposes of fees and benefits. Accordingly, customer C₁ along with all of the mortgage purchases M₁ through M_{N} made by customer C₁ over his home ownership lifetime is considered to be transaction 402, while customer C₂ along with the purchase of the single mortgage M₁ over his home ownership lifetime is considered to be transaction 404. The income made by broker 400 is not dependent on individual mortgage purchases, but rather on the membership relationship between the customer and the mortgage broker 400. In other words, the customer relationship over the membership period is the transaction, not the individual mortgage purchase.

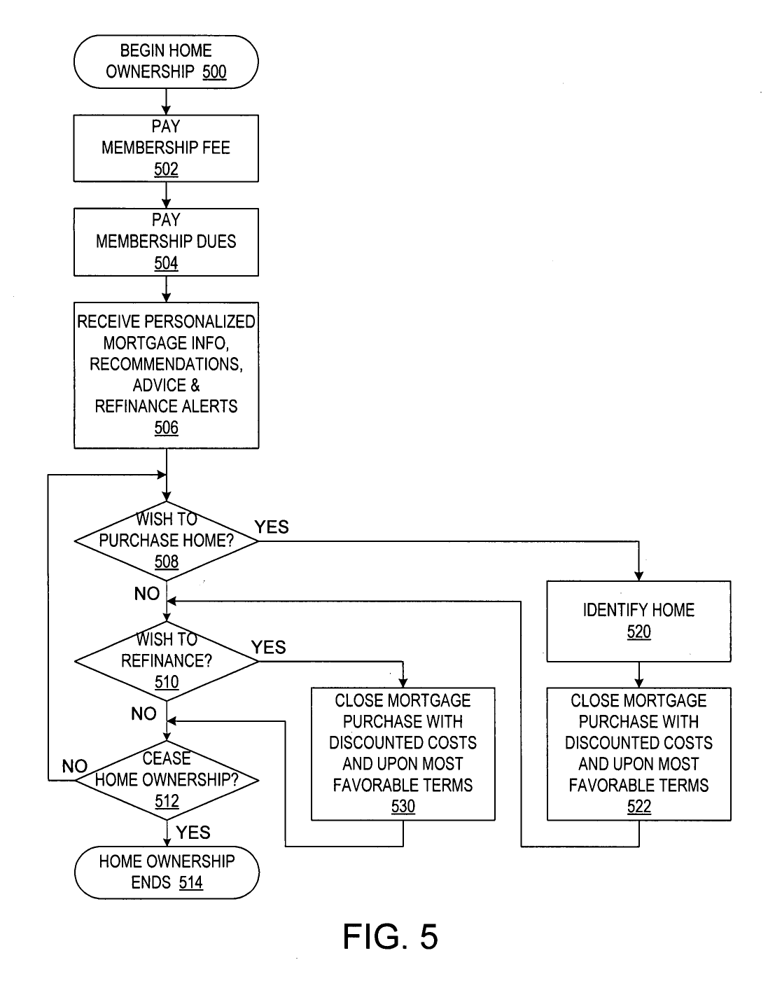

FIG. 5 shows how a customer who is a member of the membership-based mortgage purchase model may make mortgage purchases over a home purchasing lifetime. The customer pays an initial membership fee (block 502) and membership dues (block 504), the later preferably being paid periodically such as monthly. As a member, the customer may also receive customized mortgage information about home finance, and personalized recommendations about suitable mortgage products and advice for taking action for a primary, secondary, or refinance mortgage, depending on the needs of the customer as expressed to the broker 400 (block 506). The customer may also be alerted when a particularly attractive opportunity for refinance occurs (block 506). If the customer wishes to acquire a home (block 508-yes), the customer must of course identify the home (block 520) but then simply closes the mortgage purchase at discounted cost and upon the most favorable terms available in the broker's portfolio of lenders, or in the case of a direct lending institution, upon the most favorable terms the lender is willing to offer (block 522). Particularly when a broker is involved and has already fully advised the customer, there is no need to investigate the mortgage market or to identify a suitable broker, thereby greatly facilitating the process. Moreover, the customer is working with the same broker and quite possibly even the same loan officer as for prior mortgage purchases under the membership program, thereby adding a reassuring personal aspect to the relationship and removing the anxiety and frustration that can occur when working with a new broker.

If the customer receives notification from a broker or direct lending institution advising a refinance, or decides on his own that a refinance is appropriate (block 510-yes), the refinance experience is extremely easy. The customer merely contacts the broker or lender and simply closes the mortgage purchase upon the most favorable terms available in the broker's portfolio of lenders, or from the direct lending institution. Particularly when a broker is involved and has already fully advised the customer, there is no need to investigate the mortgage market or identify a suitable broker, thereby greatly facilitating the process. Moreover, the customer is working with the same broker and quite possibly even the same loan officer as for prior mortgage purchases under the membership program, thereby adding a reassuring personal aspect to the relationship and removing the anxiety and frustration that can occur when working with a new broker.

Various aspects of the program may be implemented in software.

Exemplary Fees, Restrictions and Benefits

While the basic membership fee and dues and termination fee may be set at any desired level based on customer acceptance, the personalized services offered, and the profit desired by the broker, an example of suitable fees is a one-time membership fee of $999, monthly dues of $9.95 for a minimum ten year commitment, and a termination fee of $995 or the dues balance for the remaining part of the ten year membership commitment. The termination fee may be waived if the member has not used the broker's services to close on a mortgage, or if the member relocates to an area where the broker is not licensed to do business.

The fees and closing costs charged by the broker to a member may be discounted in any desired way and to any desired level, including full waiver or full payment on behalf of the member. In a case of an original $200,000 mortgage, for example, typical fees charged to the customer under the approach presently common in the industry include an origination fee (illustratively one percent, or $2000), a processing fee (typically $300 to $500), an application, administration and document preparation fee (typically $300 to $500), a credit report fee (typically $10 to $58), and an underwriting fee (typically $500 to $800). In one example of a suitable discount, the broker waives the origination fee and the application, administration and document preparation fee, and pays the processing fee, the credit report fee, and the underwriting fee on behalf of the member. Without the discount, a customer would pay in the range of $3110 to $3858. A member pays none of these conventional fees, thereby saving from $1417 to $2165 on this single mortgage purchase even after adjusting for the membership fee and dues of $1693. In another example, the member may be given a credit against these fees, thereby ensuring the broker a predetermined payment for each mortgage purchase. A suitable credit would be the sum of the lowest fees in each category. For the exemplary amounts stated above, the credit would be $3110, so that the member would pay nothing if all fees are at the minimum and up to $748 if all fees are at the maximum.

The foregoing single mortgage purchase situation is not the most likely situation, since the average homeowner refinances every three to five years, and sells every seven to ten years. Over a thirty year period, the average homeowner makes six to ten mortgage purchases. Assuming six to ten mortgage purchases of $200,000, a homeowner would traditionally have spent from $18,660 to $38,530 on broker and lender fees. However, this same homeowner as a member would have spent only $4081. Hence, members who are like average homeowners are likely to realize significant cost savings.

Members can essentially close an infinite number of mortgage transactions for around the price of only one over a thirty year period. Moreover, the membership dues are spread out over thirty years in tiny monthly increments, which is substantially better than “eating up” a portion of a homeowner's equity to roll in closing costs each time a mortgage is taken out. The more mortgages a member closes, and the larger the loan amount, the greater the savings to the member.

Certain restrictions on the membership program may be desirable. Illustrative restrictions are as follows.

The first mortgage loan amount should be $200,000 or greater. If under $200,000, the member should pay any applicable processing and underwriting fees.

The second mortgage loan need not be limited provided that the member pays any applicable processing and underwriting fees.

Non-traditional underwriting such as Stated Income, Stated Income/State Asset, and No Documentation loans are on a case by case basis. As long as the yield spread premium paid to the broker by the lender is one percent, then the standard program guidelines may apply. If the underwriting guidelines prevent the broker from grossing one percent in yield spread premium, then the difference may be charged to the member as a broker fee.

Non-Owner Occupied and Investment Properties are also on a case by case basis. As long as the yield spread premium paid to the broker by the lender is one percent, then the standard program guidelines may apply. If the underwriting guidelines prevent the broker from grossing one percent in yield spread premium, then the difference may be charged to the member as a broker fee.

As a general rule, member benefits are available under the standard program guidelines provided that the lender compensation to the broker is equal to one percent. If the lender compensation is less than one percent due to lender pricing hits specific to the particular mortgage purchase, the member may still enjoy the standard benefits provided that the difference is to be made up by the member in the form of a broker fee. However, as a practical matter, rarely would the lender compensation not equal one percent.

If the member terminates membership, and regardless of the reason, the member may rejoin at the membership rates in effect upon rejoining. However, the member may only rejoin once. It the member terminates twice, the member may not rejoin again. This is to protect the program from being abused.

Various settlement charges preferably are not included in the program. These charges include title company charges, taxes and recording fees, appraisal fees, flood certification fees, certain pre-paid amounts such as pre-paid interest and pre-paid escrow reserves.

All mortgage applications are subject to underwriting approval, and should meet the standard guidelines set by each lender within the broker's lender portfolio. All mortgage purchases should close with the broker.

Other Implementation Exmaples

The membership program may be implemented as a franchise arrangement. Aside from the usual advantages of a comprehensive branding program and business method, the franchisor may have additional leverage to assemble a large portfolio of lenders and negotiate more favorable terms, and offer this portfolio of lenders to the franchisees. In exchange, the franchisees may pay a franchise fee and ongoing royalties and advertising contributions, and adhere to certain standards set by the franchisor. The fees, restrictions and benefits of the membership program may be modified in view of the rights and obligations established by the franchise arrangement.

The membership program may also be offered to customers through financial planners. Generally, it is extremely important to involve a financial planner in the mortgage process, as it is the case for most consumers, that their home is typically their largest asset and one that requires appropriate financial and mortgage planning for proper asset management. An experienced financial planner understands this reality, and will assist the consumer and the broker or direct lending institution in the mortgage process to ensure that the mortgage financing that the consumer chooses to implement will also be inline with their overall financial objectives as set forth with the financial planner. In addition, members minimize closing costs and the rate of interest being charged on the mortgage as inherent benefits of the program, thus maximizing the return on their real estate investment and fulfilling the fiduciary responsibility of the financial planner.

Preferably, financial planners wishing to be associated with the membership program should meet the following certification criteria. First, the candidate should have a minimum of two years financial planning experience as verified through Series 6 and Series 7 security licenses, as well as verification of employment. Second, the candidate should be currently an active financial planner. Third, financial planning should be the candidate's primary business function. Fourth, the broker/dealer of the financial planner should approve the program prior to the individual financial planner's certification.

Certified financial planners may be duly compensated for services actually performed on the mortgage request and membership enrollment process of offering the program to their clients. In one illustrative arrangement, the financial planner may be compensated upon closing in the amount of $500 for each client who determines that the program is a good fit for him or her, subject to the financial planner's performance of the required services to be performed to receive compensation. Additional eligibility requirements may be imposed. Examples of additional eligibility requirements include the following. First, the financial planner should pass a certification course offered by the broker. Second, the financial planner should thoroughly explain of all pertinent details of the program to the client. Third, a “Business Affiliate Disclosure” should be presented to and signed by client, explaining that the financial planner is affiliated with the broker and will be compensated by the broker if the client chooses to enroll into the program. Fourth, the financial planner should complete a “Personal Financial Summary” form and a “Mortgage Request & Disclosure” form for each client choosing to enroll, as well as gather all suitable documentation in support of the forms. Fifth, the financial planner should have the client sign an “Authorization to Disclose & Pull Credit Report” form, which authorizes the financial planner to release personal client information and documentation to the broker. Sixth, the financial planner should have the client sign an “Anti-Coercion Statement” verifying that the client is choosing to enroll in the program of their own free will, and that if the client receives any cash-out from mortgage financing that is reinvested with the financial planner, the client is doing so of their own free will and will hold harmless the broker and the financial planner for any gains or losses as a result of the reinvestment. Seventh, the financial planner should have the client sign a membership agreement and an auto-debit for the monthly dues and any applicable termination fee.

Revenue Examples

To evaluate the program performance over a ten year period under a conservative scenario, the following assumptions were made. New members added per year, 500; number of closed loans to new members, 95%; number of closed loans to existing members, 20%; first mortgage loan size, $200,000; one percent yield spread premium, $2000; one percent origination fee, $2000 (waived by broker); underwriting fee, $499 (paid by broker); processing fee, $375 (paid by broker); credit report, $22 (paid by broker); application fee, $350 (waived by broker); payments to employees, $377 (paid by broker); and payroll tax payment, $75.40 (paid by broker). The gross income to the broker after ten years under this scenario is $10,337,880. Under a conventional approach assuming 3 loan officers initially, 6 new loan officers added each year, average number of loans per year per loan officer, 24; one percent origination fee, $2000; one percent yield spread premium, $2000; application fee, $350; payment to loan officer, $2800 (paid by broker); and payroll tax payment, $400 (paid by broker), the gross income to the broker after ten years would be only $1,738,800. As can be seen, the member realizes significant savings even while the broker realizes an enhanced income.

To evaluate the program performance over a ten year period under a rapid growth scenario, the following assumptions were made. New members added per year, 2500; number of closed loans to new members, 95%; number of closed loans to existing members, 20%; first mortgage loan size, $200,000; one percent yield spread premium, $2000; one percent origination fee, $2000 (waived by broker); underwriting fee, $499 (paid by broker); processing fee, $375 (paid by broker); credit report, $22 (paid by broker); application fee, $350 (waived by broker); payments to employees, $377 (paid by broker); and payroll tax payment, $75.40 (paid by broker). The gross income to the broker after ten years under this scenario is $961,319,440. Under a conventional approach assuming 3 loan officers initially, new loan officers added each year double that of the prior year beginning with 12, average number of loans per year per loan officer, 24; one percent origination fee, $2000; one percent yield spread premium, $2000; application fee, $350; payment to loan officer, $2800 (paid by broker); and payroll tax payment, $400 (paid by broker), the gross income to the broker after ten years would be only $338,900,400. As can be seen, the member realizes significant savings even while the broker realizes an enhanced income.

The description of the invention and its applications and various examples as set forth herein are illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A method of providing mortgage services comprising:
establishing an entity prospectively requiring mortgage services as a member, wherein the member is obligated to make at least one payment to maintain member status;
receiving a request from the member to purchase a mortgage;
identifying a mortgage characteristic that is favorable to the member;
accessing a portfolio of mortgage products to identify a mortgage most suitably matched to the favorable mortgage characteristic, in response to the mortgage purchase request;
offering the identified mortgage to the member; and
discounting closing expenses to the member relating to closure of the offered mortgage.

2. The method of claim 1 further comprising assembling the portfolio of mortgage products, wherein the mortgage products are available from a plurality of different lenders through a broker.

3. The method of claim 1 further comprising assembling the portfolio of mortgage products, wherein the mortgage products are available from a single direct lending institution.

4. The method of claim 1 wherein the establishing step comprises receiving an initial membership fee and periodic membership dues.

5. The method of claim 4 further comprising receiving a termination fee from the member to terminate member status.

6. The method of claim 5 further comprising receiving a further membership fee and further periodic membership dues to reestablish the entity as a member.

7. The method of claim 1 wherein the favorable mortgage characteristic is lowest interest rate of mortgage products for which the member qualifies.

8. The method of claim 1 wherein the discounting step comprises waiving an origination fee from the member.

9. The method of claim 8 wherein the request from the member in the request receiving step is for a mortgage loan of a predetermined minimum amount, and wherein the discounting step further comprises:
paying an underwriting fee on behalf of the member; and
paying a processing fee on behalf of the member.

10. The method of claim 1 wherein the request from the member in the request receiving step is for a mortgage loan in an amount less than a predetermined minimum amount.

11. The method of claim 1 further comprising receiving a yield spread premium upon closure of the offered mortgage.

12. The method of claim 11 wherein the yield spread premium is one percent.

13. The method of claim 11 wherein the yield spread premium is less than one percent, further comprising receiving from the member an amount equal to one percent minus the yield spread premium.

14. The method of claim 1 wherein the member establishing step comprises soliciting the entity, wherein the solicitation is performed by a broker.

15. The method of claim 1 wherein the member establishing step comprises soliciting the entity, wherein the solicitation is performed by a direct lending institution.

16. The method of claim 1 wherein the member establishing step comprises soliciting the entity, wherein the solicitation is performed by a financial planner certified by a broker.

17. The method of claim 1 wherein the member establishing step comprises soliciting the entity, wherein the solicitation is performed by a financial planner certified by a direct lending institution.

18. A method for a broker to provide mortgage services comprising:
establishing a portfolio of lenders offering a variety of competitively priced mortgage products;
establishing an entity prospectively requiring mortgage services as a member upon receipt of an initial membership fee;
maintaining member status of the member upon receipt of periodic membership dues;
receiving a request from the member to purchase a mortgage, the request being for a first mortgage loan amount of at least a predetermined minimum amount;
offering from the portfolio of lenders a mortgage most suitably matched to the member's needs, the offered mortgage being a lowest interest rate of mortgage products for which the member qualifies;
receiving a one percent yield spread premium, in connection with closing of the offered mortgage;
waiving origination and application fees from the member, in connection with closing of the offered mortgage; and
paying processing, credit report, and underwriting fees on behalf of the member, in connection with closing of the offered mortgage.

19. A method of providing franchised mortgage services comprising:
empowering each of a plurality of brokers:
to establish an entity prospectively requiring mortgage services as a member, wherein the member is obligated to make at least one payment to maintain member status;
to receive a request from the member to purchase a mortgage;
to identify a mortgage characteristic that is favorable to the member;
to access a portfolio of mortgage products for identifying a mortgage most suitably matched to the favorable mortgage characteristic, in response to the mortgage purchase request;
to offer the identified mortgage to the member; and
to discount closing expenses to the member relating to closure of the offered mortgage; and
receiving respective fees from the brokers in consideration of the empowering step.

20. The method of claim 19 further comprising establishing the portfolio of mortgage products from a portfolio of lenders offering a variety of competitively priced mortgage products.
